(19) United States
(12) Patent Application Publication
(10) Pub. No.: US 2004/0088449 A1
(43) Pub. Date: May 6, 2004

(54) USB unit control method and a USB unit controller

(75) Inventor: Seiji Sakaki, Kanagawa (JP)

Correspondence Address: McDERMOTT, WILL & EMERY, 600 13th Street, N.W., Washington, DC, 20005-3096, US

(73) Assignee: MATSUSHITA ELECTRIC INDUSTRIAL CO., LTD.

(21) Appl. No.: 10/689,643

(22) Filed: Oct. 22, 2003

(30) Foreign Application Priority Data
Nov. 1, 2002 (JP) P.2002-320212

(51) Int. Cl. G06F 3/00

(52) U.S. Cl. 710/15

(57) ABSTRACT

Providing a method and a controller which readily performs a switchover of a dual-role device between a USB host and a USB device

The controller includes a hub function for coupling a plurality of USB units including a dual-role device acting as a USB device or a USB host, device control function for determining the function of the dual-role device assumed when it is connected, and bus management function for making a switchover of a dual-role device connected to the hub function between a USB device and a USB host based on the result of determination of the function.

### BACKGROUND OF THE INVENTION

1. Field of the Invention

The present invention relates to a method and a controller for controlling a USB unit (dual-role device) conforming to the OTG Specifications as USB Supplementary Specifications.

2. Description of the Related Art

Standard USB hub apparatus uses a USB cable to connect a USB host and a plurality of USB devices to perform USB data communications. FIG. 5 shows a configuration of a standard USB hub. In FIG. 5, standard USB hub apparatus 500 uses a HUB function 510 to connect a USB host 520 and a plurality of USB devices (two in the case of FIG. 5) to perform USB data communications. Power 540 from the USB host 550 is fed to the USB devices 551, 552. A USB system having a USB host 520 and a plurality of USB devices is also described in the Japanese Patent Laid-Open No. 2001-256172.

However, in case a USB unit conforming to the OTG Specifications is connected, related art standard USB hub apparatus does not support the Session Request Protocol or Host Negotiation Protocol defined in the OTG Specifications. Thus it is not possible to switch a dual-role device acting as a USB host or a USB device from the USB host to the USB device or vice versa. It is necessary to once remove the USB unit in order to switch to a USB device or a USB host.

### SUMARRY OF THE INVENTION

The invention has been accomplished in view of the aforementioned circumstances and aims at providing a method and a controller for controlling a USB unit which readily switches between a USB device and a USB host assumed in case a USB unit conforming to the OTG Specifications is connected.

A USB unit control method according to a first aspect of the invention is characterized in that, when coupling a plurality of USB units including a dual-role device acting as a USB device or a USB host via a hub, the method determines the function of the dual-role device assumed when it is connected, and switches the dual-role device between a USB device and a USB host. With this configuration, it is possible to readily switch a dual-role device connected to a hub between a USB device and a USB host without removing the dual-role device from the hub.

A USB unit control method according to a second aspect of the invention is a USB unit control method according to the first aspect of the invention, characterized in that, in case a dual-role device acting as a USB host is connected to a hub where a USB host is connected, the method makes a switchover of the dual-role device from a USB host to a USB device, and reports the switchover to the USB host. With this configuration, it is possible to switch a dual-role device between a USB host and a USB device.

A USB unit control method according to a third aspect of the invention is a USB unit control method according to the first aspect of the invention, characterized in that, in case all dual-role devices connected to a hub act as USB devices, the method detects the Session Request Protocol from the dual-role devices and switches the dual-role device which has started the Session Request Protocol to a USB host. With this configuration, it is possible to switch a dual-role device between a USB host and a USB device based on the connection state of the connected USB unit.

A USB unit control method according to a fourth aspect of the invention is a USB unit control method according to the first aspect of the invention, characterized in that, in case a USB host is connected to a hub via a four-wire USB cable, the method makes a switchover of all dual-role devices connected to the hub to USB devices, and reports the switchover to the USB host. With this configuration, it is possible to perform USB data communications even in case a related art USB unit is connected as a USB host.

A USB unit control method according to a fifth aspect of the invention is a USB unit control method according to the first aspect of the invention, characterized in that, in case a USB device is connected via a four-wire USB cable to a hub where a USB host is connected, the method reports connection of the USB device to the USB host. With this configuration, it is possible to perform USB data communications even in case a related art USB unit is connected as a USB device.

A USB unit control method according to a sixth aspect of the invention is a USB unit control method according to the first aspect of the invention, characterized in that the method determines the function of the dual-role device assumed when it is connected based on the state of a port where a USB unit is connected or change in the state of D+ or D− of a USB data line, and makes a switchover of the dual-role device between a USB device and a USB host. With this configuration, it is possible to make a high-precision decision by making a decision based on the state of a port where a USB unit is connected or change in the state of D+ or D− of a USB data line.

A USB unit control method according to a seventh aspect of the invention is a USB unit control method according to the first aspect of the invention, characterized in that the method detects a specific request from a USB host connected to a hub and makes a switchover of a plurality of dual-role devices between a USB device and USB host. With this configuration, it is possible to make a smooth switchover between a USB device and USB host by using a specific request which can be recognized by USB units.

A USB unit controller according to an eighth aspect of the invention is characterized in that the USB unit controller executes a USB unit control method according to any one of the first through seventh aspect of the invention. With this configuration, a USB unit controller can switch a dual-role device between a USB device and a USB host.

A USB unit controller according to a ninth aspect of the invention is a USB unit controller according to the eighth aspect of the invention, characterized in that the USB unit controller comprises a hub for coupling a plurality of USB devices including a dual-role device acting as a USB device or a USB host, device control means for determining the function of the dual-role device assumed when it is connected, and bus management means for making a switchover of a dual-role device connected to the hub between a USB device and a USB host. With this configuration, it is possible to determine the state of a dual-role device and making a switchover between a USB device and a USB host by providing new device control means and new bus management means in addition to an existing hub.

A USB unit controller according to a tenth aspect of the invention is a USB unit controller according to the ninth aspect of the invention, characterized in that the device control means comprises a function for performing communications between a USB host and a USB device, a function for performing data communications, and a function for detecting and starting the Session Request Protocol and executing the Host Negotiation Protocol. With this configuration, it is possible to perform USB data communications to/from a USB unit conforming to the OTS Specifications.

A USB unit controller according to an eleventh aspect of the invention is a USB unit controller according to the ninth or tenth aspect of the invention, characterized in that the USB unit controller comprises at least one receptacle for a USB cable defined in the OTG Supplementary Specifications and functions as a USB hub. With this configuration, the USB unit controller can function as a hub to concentrate USB units connected via USB cables defined in the OTG Supplementary Specifications.

A program according to a twelfth aspect of the invention is characterized in that the program is a program for executing a USB unit control method described in any one of the first to seventh aspects of the invention. With this configuration, it is possible to switch a dual-role device between a USB device and a USB host by way of software.

A semiconductor integrated circuit according to a thirteenth aspect of the invention is characterized in that the semiconductor integrated circuit comprises a program according to the twelfth aspect of the invention and a USB unit controller according to any one of the eighth through eleventh aspect of the invention. With this configuration, it is possible to switch a dual-role device between a USB device and a USB host by way of a combination of hardware and software.

### BRIEF DESCRIPTION OF THE DRAWINGS

FIG. 1 shows a configuration of a USB unit controller according to Embodiment 1 of the invention;

FIG. 2 shows a configuration of a USB unit controller according to Embodiment 2 of the invention;

FIG. 3 shows a configuration of a USB unit controller according to Embodiment 3 of the invention;

FIG. 4 is a flowchart showing a USB unit control method according to Embodiment 4 of the invention; and

FIG. 5 shows a configuration of related art USB hub apparatus.

### DESCRIPTION OF THE PREFERRED EMBODIMENTS

Embodiments of the invention will be described referring to drawings.

### EMBODIMENT 1

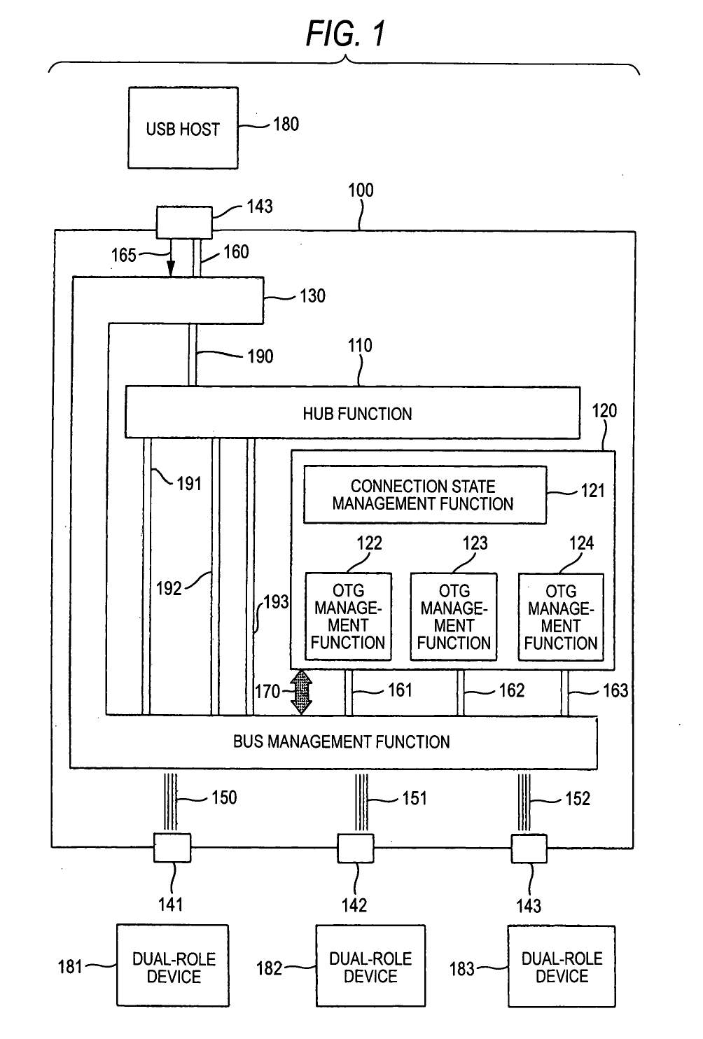

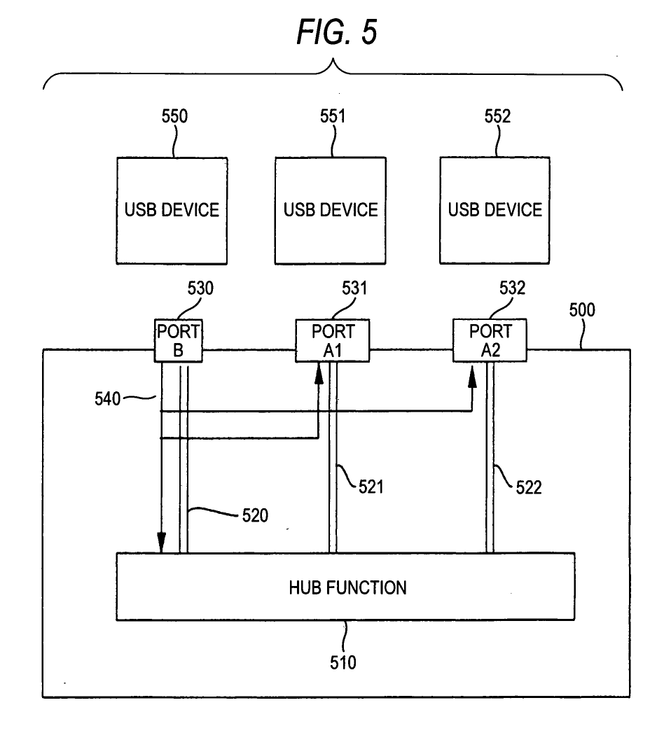

FIG. 1 shows a configuration of a USB unit controller according to Embodiment 1 of the invention. The USB unit controller 100 shown in FIG. 1 comprises a device control function 120 and a bus management function 130 on top of standard USB hub apparatus 500 shown in FIG. 5. The device control function 120 comprises a connection management function 121 for managing the connection state and the current state (a USB host or a USB device) of each of the dual-role devices 181, 182, 183 connected to port AB (141, 142, 143) and the connection order of the dual-role devices and OTG management functions 122, 123, 124 for detecting the SRP (Session Request Protocol) in the OTG Specifications and executing the HNP (Host Negotiation Protocol). The OTG management functions 122, 123, 124 are dual-role devices acting as USB hosts or USB devices.

The bus management function 130 comprises a function for detecting whether dual-role devices 181, 182, 183 are connected as USB hosts or USB devices by reading a signal on an ID line of a USB cable conforming to the OTG Specifications as well as a function for controlling power to the dual-role devices 181, 182, 183, a suspend detection function, and a function for detecting connection/disconnection of a USB unit which has no other choice but to act as a USB host, such as a PC (Personal Computer), and a function for connecting to a HUB function 110. The HUB function 110 switches the USB data line of a connected USB cable to the data line for a USB host or a USB device.

The bus management function 130 determines the connection state (a USB host or a USB device) of each of the dual-role devices 181, 182, 183 connected to the USB unit controller 100 and reports the result to a device control function 120 per dual-role device via a control line 170. The state of each of the connected dual-role devices 181, 182, 183 can be determined by checking the state (H, L) of the Vbus terminal of the USB cable. In case a dual-role device is connected as a USB host, the bus management function 130 determines the state of the dual-role device by detecting H (high level) of the Vbus terminal of the USB cable. In case a dual-role device is connected as a USB device, the bus management function 130 determines the state of the dual-role device on the ID terminal (fixed to L) of the USB cable.

### EMBODIMENT 1-1

A case where a plurality of dual-role devices are connected as USB hosts to the USB unit controller 100 will be described. The device control function 120, detecting the connection state (a USB host or a USB device) to a USB cable, records the connection state of the dual-role device in the connection state management function 121. Under the control of the device control function 120, the bus management function 130 switches, as a USB host, the dual-role device connected first as a USB host to a data line 190 for a host.

A dual-role device connected as another host is managed by the OTG management function until the Host Negotiation Protocol (HNP) is executed. When the Host Negotiation Protocol (HNP) is executed, the device control function 120 controls the bus management function 130 to switch USB data lines 161, 162, 163 to data lines 191, 192, 193 for devices.

### EMBODIMENT 1-2

A case where all dual-role devices 181, 182, 183 are connected as USB devices to the USB unit controller will be described. The device control function 120, detecting the connection of a USB cable, records the connection states of the dual-role devices in the connection state management function 121. The device control function 120 then controls the bus management function via a control line 170 so that the Vbus for a USB bus signal will be driven High.

When the USB unit controller 100 and dual-role devices are connected via USB cables, the dual-role devices and the OTG management functions start USB data communications. The OTG management functions 122, 123, 124 performs USB data communications with corresponding dual-role devices 181, 182, 183 respectively.

When a communications-ready states (except Ep0 as well) are established between dual-role devices and the OTG management functions, the device control function 120 makes control to drive Low the Vbus of a USB bus corresponding to the bus management function 130. When the Session Request Protocol (SRP) is started from a dual-role device, the device control function 120 controls the bus management function via a control line 17b so that the Vbus for a USB bus signal will be driven High. Further, the OTG management function for managing a dual-role device which has started the Session Request Protocol (SRP) executes the Host Negotiation Protocol (HNP) while controlling the bus management function 130. The device control function 120 changes a data line which has transmitted the Session Request Protocol (SRP) to a data line 190 for a host. After this change, the device control function 120 switches the data lines for dual-role devices which have not transmitted the Session Request Protocol (SRP) to data lines 193 for devices not in use.

For example, in case the Session Request Protocol (SRP) is executed between a dual-role device 181 and an OTG management function 122, for the dual-role device 181, a USB data line 161 for port AB1 is disconnected and switched to the data line 190 for a host. For the dual-role devices 182, 183, USB data lines 162, 163 for ports AB2, 3 are disconnected and switched to the data lines 191, 192 for devices. When the Session Request Protocol (SRP) is executed simultaneously by a plurality of dual-role devices, operation is made in accordance with the priority between ports AB (141, 142, 143) or the connection order and initial connection state managed by the connection state management function.

### EMBODIMENT 1-3

A case where one of the dual-role devices 181, 182, 183 acts as a USB host and the other dual-role devices as USB devices and USB data communications are performed, for example a case where a USB host 180 which operates only as a USB host (such as a PC) is connected to a port B (143) will be described.

A bus management function 130 detects a Vbus 165 of a port B and reports to a device control function 120. The device control function 120 controls a bus management function 130 to switch data lines 191, 192, 193 currently used for dual-role devices to USB data lines 161, 162, 163 for port AB, and connect a USB data line 160 for a port B to a data line 190 for a host. The device control function 120 checks that dual-role devices 181, 182, 183 operate as USB devices and switches the corresponding data lines to the data lines 191, 192, 193.

When the USB host 180 is disconnected, the bus management function 130 detects the disconnection and reports to the device control section 120 via a control line 170. The device control function 120 switches the data lines 191, 192, 193 for devices to the USB data lines 161, 162, 163 for port AB. The device control function 120 also switches any one of the dual-role devices 180, 181, 182, 183 to a USB host and switches the USB data lines 161, 162, 163 to the corresponding data lines 191, 192, 193 for devices. Switchover control is made in a similar way to Embodiments 1-1 and 1-2. Selection of a dual-role device 180, 181, 182 or 183 as a USB host is made in accordance with the priority between ports AB 141, 142, 143 or the connection order and initial connection state managed by the connection state management function 121. In case a dual-role device acting as a USB host is not found, it is also possible to determine a USB host through execution of the Session Request Protocol (SRP) by a dual-role device with the Vbus of a USB cable driven Low.

### EMBODIMENT 1-4

A case where a switchover of dual-role devices between a USB host and a USB device is made will be described. A bus management function 130, detecting a USB suspend signal from a USB host 180, reports to a device control function 120 via a control line 170. The device control function 120 controls the bus management function 130 so that dual-role devices 181, 182, 183 connected can perform USB data communications with an OTG management function and switches data lines 191, 192, 193 for devices to USB data lines 161, 162, 163 for port AB.

The device control function 120 compares the state (state of a connected port) managed by a connection state management function of the device control function 120 with a change in the state of a data line (D+/D−) from a dual-role device to detect a dual-role device to act as a USB host. The device control function 120 then controls the bus management function 130 to switch the USB data line of the dual-role device to act as a USB host (any one of the USB data lines 161, 162, 163 for port AB) to a data line 190 for a host.

The device control function 120 checks that the remaining dual-role devices operate as USB devices and switches the USB data lines 161, 162, 163 to corresponding data lines 191, 192, 193 for devices. Switchover control is made in a similar way to Embodiments 1-1 and 1-2.

In detecting a dual-role device to act as a USB host, in case a plurality of devices among the devices 181, 182, 183 are candidates for a USB host, determination is made in accordance with the priority between ports AB (141, 142, 143) or the connection order and initial connection state managed by the connection state management function 121. In case a USB unit which has no other choice but to act as a USB host, the device control function 120 skips data line switchover.

### EMBODIMENT 1-5

A case where a dual-role device is connected as a USB host and the power (Vbus) of a USB cable is driven Low will be described. The bus management function 130, detecting that the power of the host is driven Low, reports to a device control function 120 via a control line 170. The device control function 120 then controls the bus management function 130 to switch the data lines of all dual-role devices to USB data lines 161, 162, 163 for port AB so that the data lines can communicate with an OTG management function. Then, same as Embodiments 1-1 through 1-4, the device control function 120 controls the dual-role devices acting as a USB host and USB devices.

### EMBODIMENT 1-6

By adding data lines 191, 192, 193 for devices, USB data lines 161, 162, 163 for ports AB, bus signals 150, 151, 152, ports AB1 (141), AB2 (142), AB3 (143), a port B and corresponding OTG management functions, it is possible to arbitrarily increase the number of dual-role devices connected.

As mentioned hereinabove, according to Embodiment 1, it is possible to readily switch a dual-role device between a USB host and a USB device.

### EMBODIMENT 2

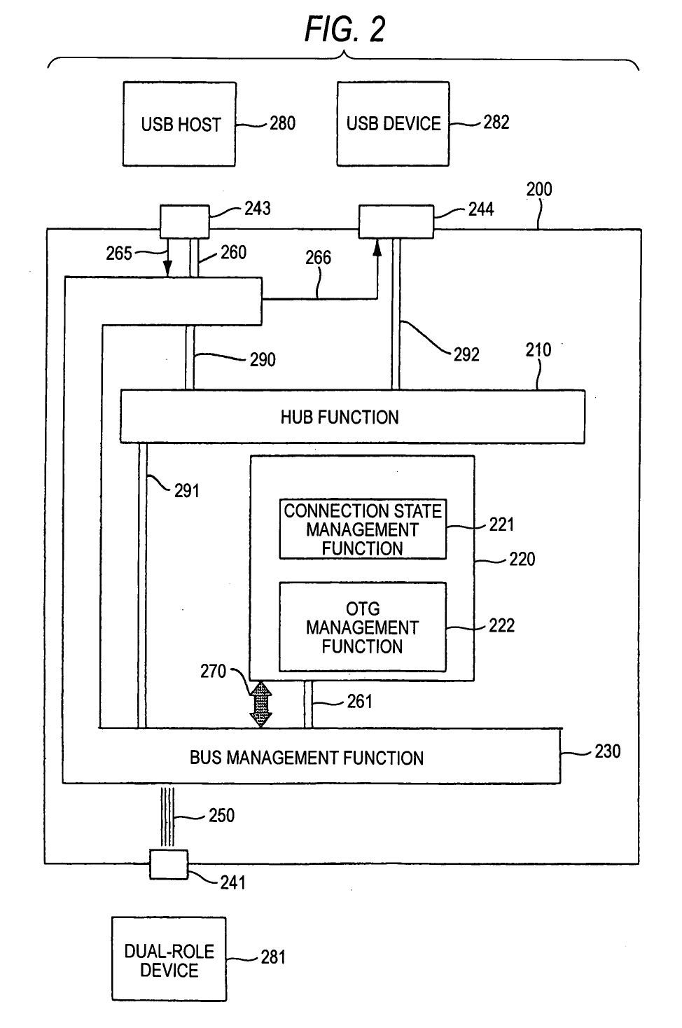

FIG. 2 shows a configuration of a USB unit controller according to Embodiment 2 of the invention. A USB unit controller 200 shown in FIG. 2 comprises a device control function 220, a bus management function 230, and a Vbus 266 of a port A as a power line (Vbus) drawn from the bus management function 230, on top of standard USB hub apparatus 500 shown in FIG. 5. The USB unit controller 200 comprises a port AB1 for connecting a dual-role device 281, a port B for connecting a USB host 280, and a port A for connecting a USB host 282. The device control function 220 comprises a connection state management function 221 for managing the connection state and the current state of a dual-role device 281 and the connection order of dual-role devices and an OTG management function 222 for detecting the Session Request Protocol (SRP) in the OTG Specifications and executing the Host Negotiation Protocol (HNP). Basic operation of the USB unit controller 200 is the same as that in Embodiment 1 except for power feeding.

### EMBODIMENT 2-1

A case where data communications are made between the USB host 280 (for example a PC) or a USB device 282 (for example a digital camera or a printer) will be described. The device control function 220, detecting the connection of the USB host 280, controls the bus management function 230 to feed power to the Vbus 266 of the port A by using the Vbus 265 of the port B from the USB host. In case the power (voltage, current) at the Vbus 265 of the port B from the USB host is insufficient, the device control function can use its built-in power source to add the power.

When power fed via the Vbus 265 of the port B from the USB host is suspended (interrupted), the bus management function 230 detects disconnection of the USB host 280 based on a change in the voltage at the Vbus 265 of the port B and reports to the device control function 20 via a control line 270. The device control function 220 controls the bus management function 230 to shut down the power feeding to the Vbus from the port A.

### EMBODIMENT 2-2

A case where a dual-role device 281 connected in the initial connection state as a USB device performs data communications with a USB device 282 (for example a digital camera or a printer) will be described.

When a USB device is switched to a USB host, the device control function 220 of a USB unit controller 200 executes the Host Negotiation Protocol (HNP) on a dual-role device 241 to switch the dual-role device 281 to a USB host. The device control function 220 controls the bus management function 230 to feed power to the Vbus of the port A (244) from its built-in power source. The device control function 220, switching a data line for a host to a USB data line 261 for a port AB, controls the bus management function 230 to shut down the power feeding to the Vbus 266 of the port A.

### EMBODIMENT 2-3

A case where a dual-role device 281 connected in the initial connection state as a USB host performs data communications with a USB device (for example a digital camera or a printer) will be described. The bus management function 230 of USB unit controller 200 switches a USB data line 261 for a port AB1 to a data line 290 for a host under control of a device control function 220. The device control function 220 controls the bus management function 230 to feed power to the Vbus of the port A (244) from power 250 (Vbus) from the dual-role device or its built-in power source. The bus management function 230 chooses the power source. The device control function 220, switching a data line for a host to a USB data line 261 for a port AB, controls the bus management function 230 to shut down the power feeding to the Vbus 266 of the port A.

### EMBODIMENT 2-4

By adding the Vbus 266 of a port A, a port A 244, and a data line 291 for a device to a USB unit controller 200, it is possible to increase the number of USB devices connected, same as related art USB hub apparatus.

According to Embodiment 2, it is possible to perform USB data communications with USB devices connected in accordance with the related art.

### EMBODIMENT 3

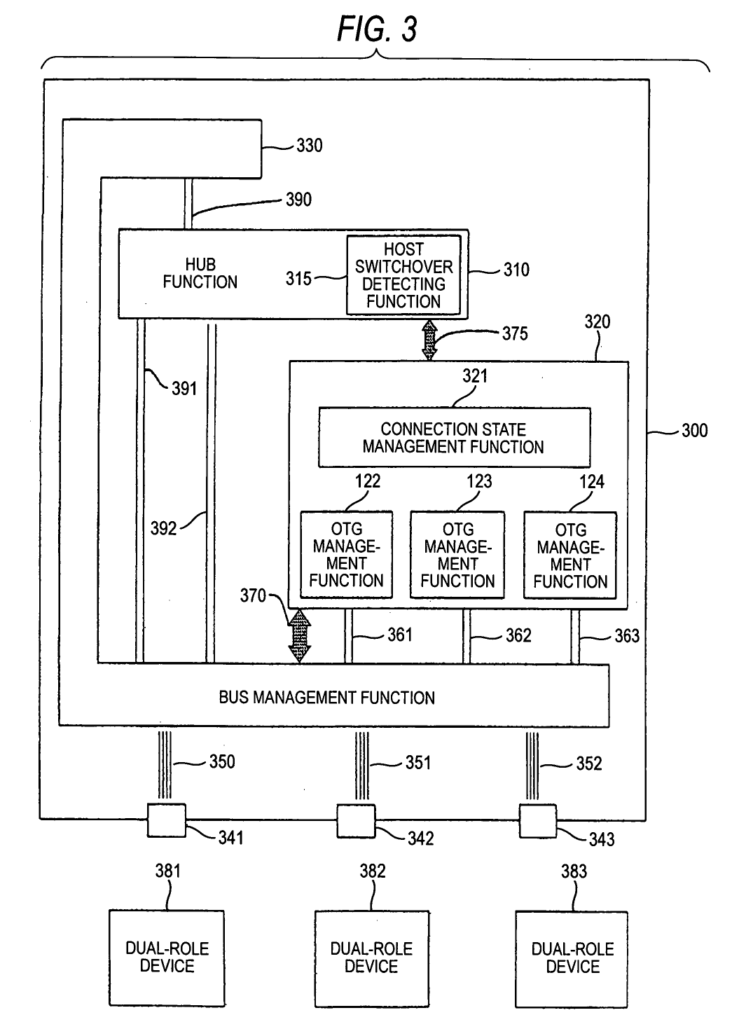

FIG. 3 shows a configuration of a USB unit controller according to Embodiment 3 of the invention. The USB unit controller 300 shown in FIG. 3 comprises a device control function 320 and a bus management function 330 on top of standard USB hub apparatus shown in FIG. 5. The USB unit controller 300 comprises a port AB1 (341) for connecting a dual-role device 381, a port AB2 (342) for connecting a dual-role device 382, and a port AB3 (343) for connecting a dual-role device 383. A HUB function 310 comprises a host switchover detecting function 315. Basic operation of the USB unit controller 300 is the same as that in Embodiment 1 except for the host switchover detecting function 315.

Functions of the host switchover detecting function 315 will be described. A USB unit conforming to the OTG Specifications can specify a USB unit to which it connects. Thus, the host switchover detecting function 315 is added so as to communicate a specific request (USB packet data, for example a vendor request) between a USB unit controller and a dual-role device.

This allows the host switchover detecting function 315 to detect information items such as a dual-role device acting next as a USB host, L output of the Vbus of a USB cable, and execution of the Host Negotiation Protocol (HNP) in cooperation with the USB unit controller.

The host switchover detecting function 315, detecting any one of the information items, reports the detected information to the device control function 320 via a control line 375. The host switchover detecting function 315 can respond to a dual-role device acting as a USB host under the control of the device control function 320.

This allows the device control function 320 to determine the connection state and smoothly switch between data lines 390, 391, 392 and USB data lines 361, 362, 363 for ports AB.

According to Embodiment 3 of the invention, it is possible to smoothly switch between the functions of a dual-role device (a USB host and a USB device) to perform USB data communications.

### EMBODIMENT 4

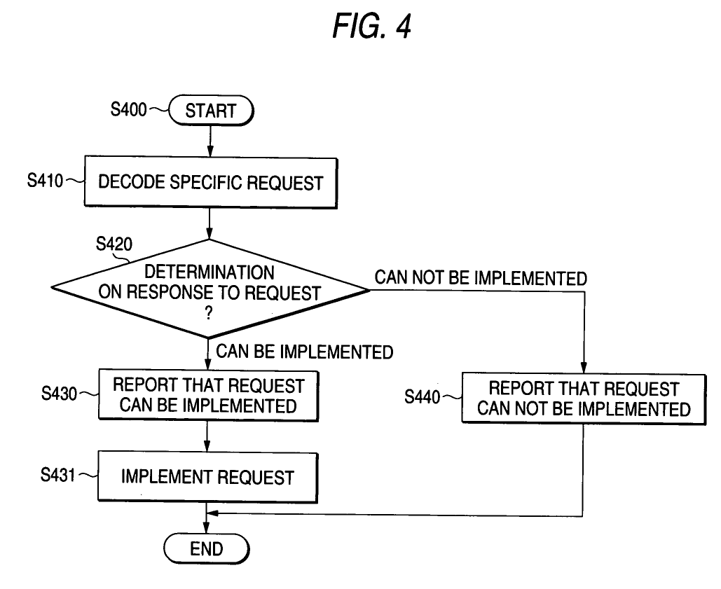

FIG. 4 is a flowchart showing the procedure for detecting via software an event such as management of USB unit connection state, detection of connection/disconnection of a USB unit, and detection of the Session Request Protocol (SRP). By detecting via software these events in Embodiments 1, 2 and 3, it is possible to switch a dual-role device connected to a USB unit controller 100, 200, 300 to a USB host or a USB device by way of a program.

Assume that the dual-role device 381 in FIG. 3 operates as a USB host and dual-role device 382, 383 as USB devices. When a specific request to switch the dual-role device 381 to a USB host is sent from the dual-role device 381 to the USB unit controller 300, the USB unit controller 300 operates in accordance with the flowchart shown in FIG. 4.

The USB unit controller 300 decodes the specific request in step S410 and determines whether the request can be implemented. In case the request cannot be implemented, execution proceeds to step S440, where the USB unit controller 300 reports to the dual-role device 381 that the request cannot be implemented. In case the request can be implemented execution proceeds to step S430, where the USB unit controller 300 reports to the dual-role device 381 that the request can be implemented.

After the report, execution proceeds to step S431, where the USB unit controller 300 switches the dual-role device 381 to a USB device in accordance with Embodiment 3, as well as switches the dual-role device 382 to a USB host. This allows USB data communications between the USB host and the USB device.

According to Embodiment 4 of the invention, it is possible to control the state (a USB device or a USB host) of a USB unit connected to the USB unit controller 100 by way of a program.

### EMBODIMENT 5

BY using a combination of any of Embodiments 1 through 4, it is possible to readily switch a dual-role device, as USB hub apparatus conforming to the OTG Specifications, between a USB host and a USB device.

As mentioned hereinabove, according to the invention, it is possible to readily switch a dual-role device connected to a hub between a USB device and a USB host without removing the dual-role device from the hub. Even in case a related art USB host and/or USB devices are used together with dual-role devices, USB data communications which recognizes a USB host and USB devices is made available.

What is claimed is:

1. A USB unit control method, wherein, when coupling a plurality of USB units including a dual-role device acting as a USB device or a USB host via a hub, said method determines the function of said dual-role device assumed when it is connected, and switches said dual-role device between a USB device and a USB host.

2. A USB unit control method according to claim 1, wherein, in case a dual-role device acting as a USB host is connected to a hub where a USB host is connected, said method makes a switchover of said dual-role device from a USB host to a USB device, and reports said switchover to said USB host.

3. A USB unit control method according to claim 1, wherein, in case all dual-role devices connected to a hub act as USB devices, said method detects the Session Request Protocol from said dual-role devices and switches the dual-role device which has started the Session Request Protocol to a USB host.

4. A USB unit control method according to claim 1, wherein, in case a USB host is connected to a hub via a four-wire USB cable, said method makes a switchover of all dual-role devices connected to said hub to USB devices, and reports said switchover to said USB host.

5. A USB unit control method according to claim 1, wherein, in case a USB device is connected via a four-wire USB cable to a hub where a USB host is connected, said method reports connection of said USB device to said USB host.

6. A USB unit control method according to claim 1, wherein said method determines the function of said dual-role device assumed when it is connected based on the state of a port where a USB unit is connected or change in the state of D+ or D− of a USB data line, and makes a switchover of said dual-role device between a USB device and a USB host.

7. A USB unit control method according to claim 1, wherein said method detects a specific request from a USB host connected to a hub and makes a switchover of a plurality of dual-role devices between a USB device and a USB host.

8. A USB unit controller, wherein said USB unit controller executes a USB unit control method according to any one of claims 1 through 7.

9. A USB unit controller according to claim 8, wherein said USB unit controller comprises
a hub for coupling a plurality of USB devices including a dual-role device acting as a USB device or a USB host,
device control means for determining the function of said dual-role device assumed when it is connected, and
bus management means for making a switchover of a dual-role device connected to said hub between a USB device and a USB host.

10. A USB unit controller according to claim 9, wherein said device control means comprises a function for performing communications between a USB host and a USB device, a function for performing data communications, and a function for detecting and starting the Session Request Protocol and executing the Host Negotiation Protocol.

11. A USB unit controller according to claim 9 or 10, wherein said USB unit controller comprises at least one receptacle for a USB cable defined in the OTG Supplementary Specifications and functions as a USB hub.

12. A program wherein said program is a program for executing a USB unit control method described in any one of claims 1 through 7.

13. A semiconductor integrated circuit wherein said semiconductor integrated circuit comprises a program according to claim 12 and a USB unit controller according to any one of claims 8 through 11.
